(19) United States
(12) Patent Application Publication
(10) Pub. No.: US 2025/0273898 A1
(43) Pub. Date: Aug. 28, 2025

(54) VACUUM SOLDERED CONNECTOR HAVING AN INSULATOR WITH A CHECK VALVE TO PREVENT WATER INGRESS

(71) Applicant: John Mezzalingua Associates, LLC, Liverpool, NY (US)

(72) Inventors: Jeremy Benn, Liverpool, NY (US); Dominick MADONNA, Baldwinsville, NY (US); Thomas URTZ, Liverpool, NY (US)

(21) Appl. No.: 18/701,098

(22) PCT Filed: Oct. 17, 2022
(86) PCT No.: PCT/US2022/078195

§ 371 Date: Apr. 12, 2024

Related U.S. Application Data
(60) Provisional application No. 63/256,363, filed on Oct. 15, 2021.

(51) Int. Cl. H01R 13/52; H01R 24/40; H01R 103/00

(52) U.S. Cl. CPC H01R 13/5202; H01R 24/40; H01R 2103/00

(57) ABSTRACT

An RF connector has an insulator that allows water to pass through it away from any solder connections but blocks the ingress of water from the outside into the RF connector's solder joints. The insulator comprises a check valve means. The check valve means may be disposed out the outer cylindrical surface of the insulator and may have one or more Tesla valve structures.

### CROSS REFERENCE TO RELATED APPLICATIONS

This application claims the benefit of priority to U.S. Provisional Application 63/256,363, filed Oct. 15, 2021, which is incorporated by reference herein in its entirety.

### BACKGROUND OF THE INVENTION

### Field of the invention

The present invention relates to wireless communications, and more particularly, to connectors that are attached to radio frequency (RF) cables using vacuum solder techniques.

### Related Art

Vacuum soldering is an established technique for attaching an RF connector to an RF cable so that contaminants (e.g., bubbles or impurities) are removed, assuring an optimal solder connection. Conventional connectors may have holes disposed in the connector's insulator component that enables air and water to be removed during the vacuum soldering process. However, there are deficiencies with conventional approaches. In particular, water may subsequently enter through the holes in the insulator when the connector is not mated. If this happens, the water may cause problems for the connector: it may cause corrosion; it may lead to variable return loss for the connector; and it may possibly lead to short circuiting during operation.

Accordingly, what is needed is an RF connector having an insulator that allows air and water to be removed during soldering but prevents water from entering the connector afterwards and when the connector is not yet mated.

### SUMMARY OF THE DISCLOSURE

An aspect of the present disclosure involves an RF connector. The RF connector comprises a connector body; a center contact; and an insulator disposed between the connector body and the center contact, wherein the insulator includes a check valve means.

### BRIEF DESCRIPTION OF THE DRAWINGS

FIG. 1 illustrates an exemplary jumper having an insulator with an exemplary check valve according to the disclosure.

FIG. 2A illustrates an exemplary insulator with check valve according to a first embodiment of the disclosure.

FIG. 2B illustrates a simulation of the function of a Tesla valve as used in in the exemplary insulator of FIG. 2A.

FIG. 3 illustrates an exemplary insulator with a check valve according to a second embodiment of the disclosure.

FIG. 4 is a cross section illustration of the exemplary connector of FIG. 1.

### DESCRIPTION OF EXEMPLARY EMBODIMENTS

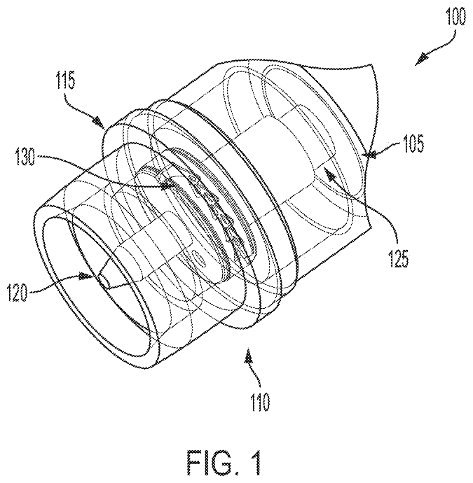

FIG. 1 illustrates an exemplary jumper 100 having an insulator with an exemplary check valve according to the disclosure. Jumper 100 includes an RF cable 105; and an RF connector 110 disposed on the RF cable 105. RF connector 110 has a connector body 115 and a center contact 120, which is electrically coupled to an inner conductor 125 of RF cable 125. Disposed between center contact 120 and connector body 115 is an insulator 130 according to the disclosure.

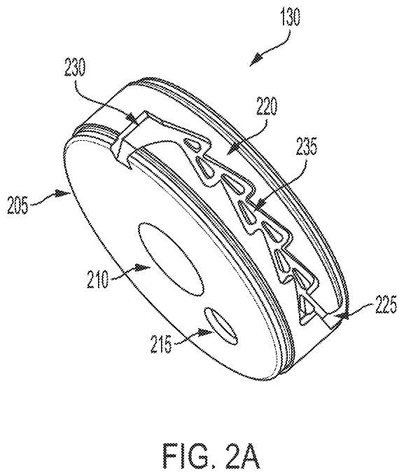

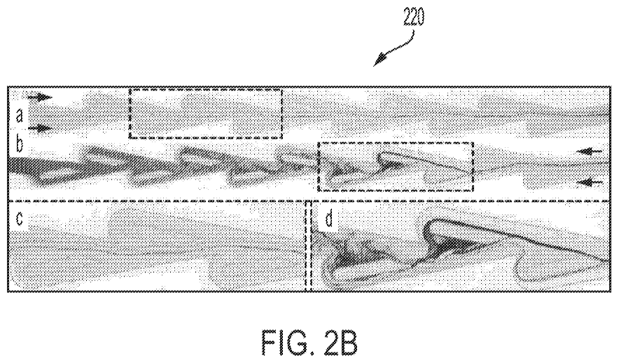

FIG. 2A illustrates an exemplary insulator 130 according to a first embodiment of the disclosure. Insulator 130 has a disk-shaped body 205 having an aperture 210 in which center contact 120 is disposed once assembled, and an orientation indication feature 215, which is only formed on the surface of body 205 and does not pass through. Disposed on the outer ring surface of body 205 is a check valve 220. Exemplary check valve 220 has an input port 225 and an output port 230. Check valve 220 also has, located between input port 225 and output port 230, a plurality of Tesla valve structures 235. The Tesla valve structures 235 form a passive check valve whereby water may flow from input port 225, through the Tesla valve structures 235 and through the output port 230 to escape the connector 110. However, the shape of each Tesla valve 235 is such that any water ingress into output port 230 is obstructed by the Tesla valve structures 235, whereby a given Tesla valve channels water into two paths such that the two paths interfere with each other, creating a turbulence that creates a high pressure area, thereby obstructing the water flow.

The outer surface of insulator body 205, on which the check valve 220 is disposed, makes mechanical contact with the inner surface of connector body 115 when insulator 130 is press fit into connector body 115 around center contact 110, causing check valve 220 to have a narrow channel for air and water to flow outward from connector 110 when connector 110 is vacuum soldered to RF cable 105, while, according to the design of check valve 220, prevents water from flowing in afterwards.

FIG. 2B illustrates a simulation of the function of a Tesla valve 235 as used in the check valve 220 of exemplary insulator 130 of FIG. 2A.

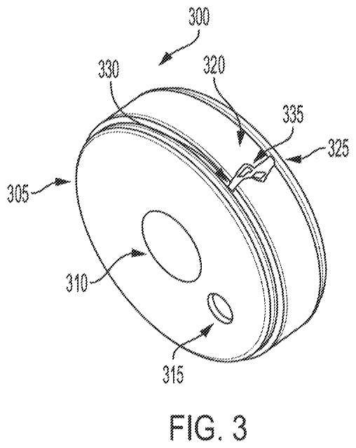

FIG. 3 illustrates an exemplary insulator 300 according to a second embodiment of the disclosure. Insulator 300 has a disk-shaped insulator body 305 having an aperture 310 in which center contact 120 is disposed once assembled, and an orientation indication feature 315, which is only formed on the surface of body 305 and does not pass through. Disposed on the outer ring surface of body 305 is a check valve 320. Exemplary check valve 320 has an input port 325 and an output port 330. Check valve 220 also has, located between input port 325 and output port 330, a single Tesla valve structure 335. The Tesla valve structure 335 forms a passive check valve whereby water may flow from input port 325, through the Tesla valve structures 335 and through the output port 330 to escape the connector 110.

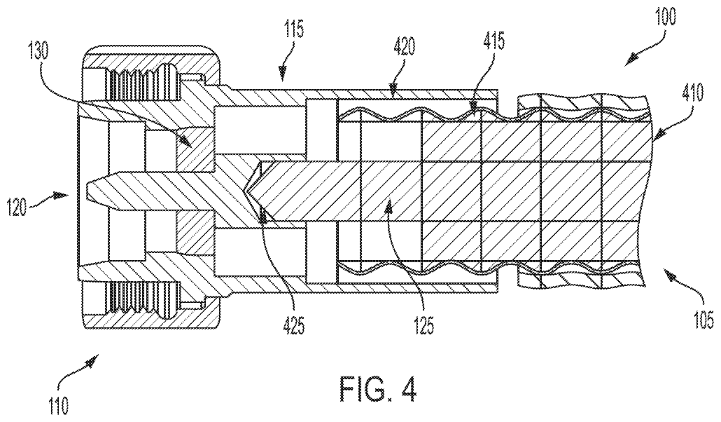

FIG. 4 is a cross section illustration of exemplary jumper 100 having an insulator 130 according to the disclosure. Similar to that illustrated in FIG. 1, jumper 100 includes RF cable 105 and RF connector 110 disposed on RF cable 105. Also illustrated are connector body 115 and center contact 120, which is electrically coupled to inner conductor 125 of RF cable 125 via center conductor solder joint 425. Disposed between center contact 120 and connector body 115 is insulator 130 according to the disclosure. As illustrated, connector body 115 is electrically coupled to an outer conductor 415 of RF cable 105. Further illustrated is dielectric 410 disposed between inner conductor 120 and outer conductor 415.

Other embodiments of insulator 130 are possible and within the disclosure. For example, other variations of check valve 220/320 are possible. For example, a check valve may include a pass through aperture (not shown) with a passive valve that is oriented in such a way that air and water may pass out from the solder joints but may not pass the other way. Alternatively, the check valve may include one or more holes that may be plugged after the vacuum soldering process. In another variation, the check valve may include a plurality of holes having a diameter having a diameter such that the surface tension of water may prohibit passage or provide capillary action such that water within the jumper may pass outward. It will be understood that such variations are possible and within the scope of the invention.

What is claimed is:

1. An RF connector, comprising:
a connector body;
a center contact; and
an insulator disposed between the connector body and the center contact, wherein the insulator includes a check valve means.

2. The RF connector of claim 1, wherein the check valve means comprises:
an input port;
an output port; and
a plurality of Tesla valve structures disposed between the input port and the output port.

3. The RF connector of claim 1, wherein the check valve means comprises:
an input port;
an output port; and
a Tesla valve structure disposed between the input port and the output port.
